(19) United States
(12) Patent Application Publication
(10) Pub. No.: US 2016/0090115 A1
(43) Pub. Date: Mar. 31, 2016

(54) SYSTEM ASSISTING THE MOVEMENT ON STEEP SURFACES

(71) Applicant: DECYLION Sp. z o.o., Warszawa (PL)

(72) Inventor: Marcin Grochowina, Rzeszow (PL)

(73) Assignee: DECYLION Sp. z o.o., Warszawa (PL)

(21) Appl. No.: 14/433,951

(22) PCT Filed: Oct. 31, 2014
(86) PCT No.: PCT/PL2014/000122

§ 371 Date: Apr. 7, 2015

(30) Foreign Application Priority Data
Sep. 30, 2014 (PL) P.409659

(51) Int. Cl. B62B 9/02

(52) U.S. Cl. CPC B62B 9/02

(57) ABSTRACT

The system assisting the movement on steep surfaces provided with a cam mechanism is characterized in that the cam mechanism (5), which is a bistable system holding the wheels (1) in contact with the substrate (2) and the second one raised vertically above the first one, wherein the wheel (1) is connected with the connector (3), through which the axis (4) of the cam mechanism (5) passes in the middle of its length, which is composed of the ellipsoidal cam (8) rigidly fixed on the axle (4), which is positioned in one of two stable positions by means of the clamp (7), through the spring (6) resting on the body (9) of the mechanism (4). The ellipsoidal cam (8) and the clamp (7) are made of the material providing a low coefficient of friction.

The invention relates to the system assisting the movement on steep surfaces by bicycles or prams in particular the stairs in stairwells or high curbs at sidewalks. Despite the intensification of efforts to eliminate architectural barriers, they occur too often, particularly in the civil structures from the last century. Often, reconstruction or modernization of existing facilities is not possible for technical or financial reasons. Specific problems with overcoming stairs or high curbs affect people carrying children in prams. The small wheels and low-suspension require either lifting the whole pram to overcome stairs or pull the pram back in turn for the next steps. The first solution requires the help of another person, which is not always possible, whereas the second solution makes a strong vibration when hitting the pram wheels against the next steps, which vibrations are transmitted through the pram onto the child contained therein. Shock and vibration can adversely affect the child's psyche.

A bike is known from the Polish patent application P.354734, which has two pivotal levers rotatably attached to the frame and the driving link connected to the said levers and banded on the wheels of the drive train, associated with the driven running wheel. The bike is fitted with a steering handle with a winding pulley and the two circuits of steering cords, one circuit assigned to a separate pivotal lever. The steering cords are connected with the winding pulley from one side, and with the sliders, slidably installed on the pivotal levers, from the other.

The invention involves the use of a mechanical system that enables to overcome the stairs with no impact. This system consists of fittings, gears and levers and provides the linearization of trajectory of the center of gravity of the pram while traveling along an inclined surface divided into steps in the classical way, i.e. the stairs of approximately the same height and width.

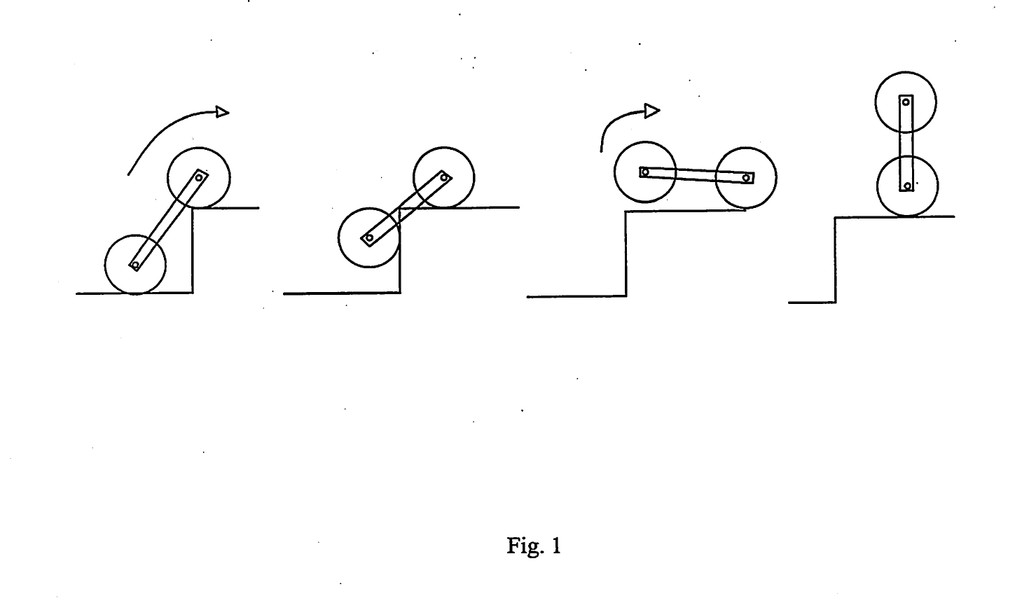

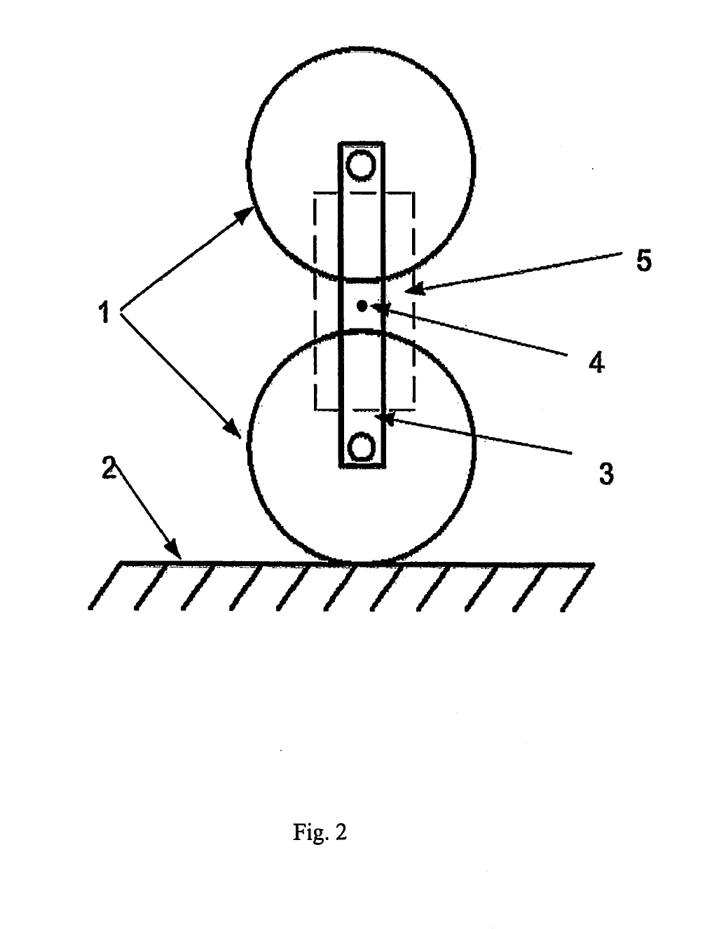

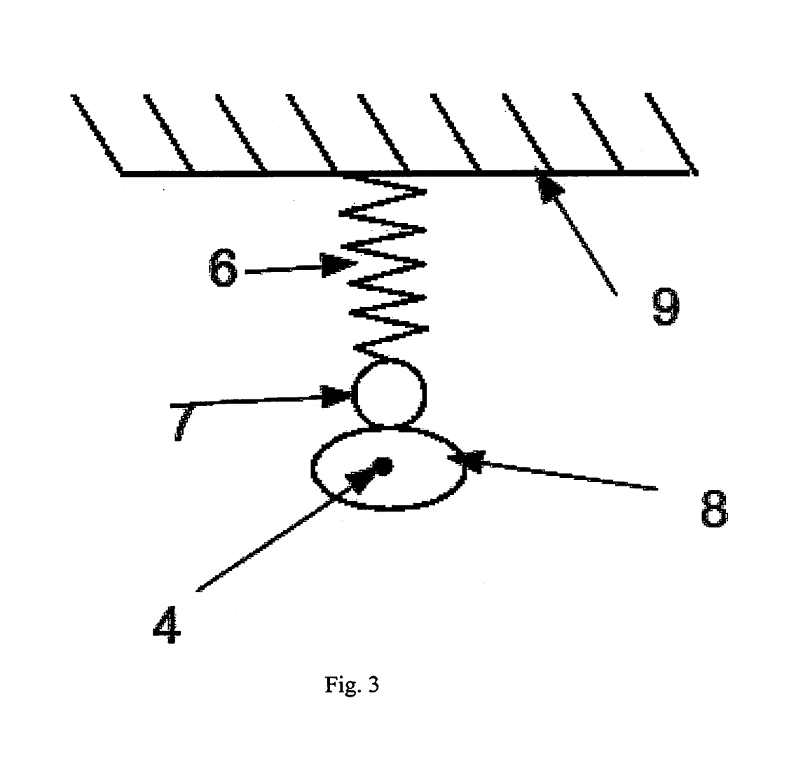

The invention is demonstrated in the exemplary embodiment in the schematic drawing in which fig. shows the steps of going up the stairs, FIG. 2 shows a general scheme of the mechanism and FIG. 3 shows a cam mechanism.

The wheels 1 are held vertically by the cam mechanism 5, which is a bistable system, i.e. it has two stable positions when one of the wheels 1 touches the substrate 2 and the other is raised vertically above the first one. The wheels 1 are connected with a connector 3 through which the axis 4 of the cam mechanism 5 passes in the middle of its length. The cam mechanism 5 is composed of the ellipsoidal cam 8 rigidly fixed on the axle 4, which is positioned in one of two stable positions by means of the clamp 7, pressed with the spring 6 resting on the body 9 of the mechanism 4. The cam 8 and the clamp 7 are made of a material providing a low coefficient of friction so that rotation of the cam 8 from the balance position compresses the spring 6, which prevents the rotation and forces the return of the cam 8 along with the system of the connector 3 and wheels 1 to one of the two possible vertical positions. The mode of action of the proposed mechanical system consists in that the system causes the pram wheels to be raised between the edges of steps, resulting in the motion along the waved line or—in the optimal case—the straight line inclined at an angle determined by a straight line connecting the vertices of stairs in a transverse projection, instead of a polygonal curve. Linearization of the pram track occurs by means of an additional mechanism, independent of the wheels and on-demand-triggered.

1. The system assisting the movement on steep surfaces provided with a cam mechanism characterized in that, it has the cam mechanism (5), which is a bistable system holding the wheels (1) in contact with the substrate (2) and the second one raised vertically above the first one, wherein the wheel (1) is connected with the connector (3), through which the axis (4) of the cam mechanism (5) passes in the middle of its length.

2. The system of claim 1 characterized in that, the cam mechanism (5) is composed of the ellipsoidal cam (8) rigidly fixed on the axle (4), which is positioned in one of two stable positions by means of the clamp (7), through the spring (6) resting on the body (9) of the mechanism (4).

3. The system of claim 2 characterized in that, the cam (8) and the clamp (7) are made of a material providing a low coefficient of friction.
